(19) United States
(12) Patent Application Publication
(10) Pub. No.: US 2018/0035409 A1
(43) Pub. Date: Feb. 1, 2018

(54) MITIGATION OF RATE MATCHING ERRORS IN A WIRELESS NETWORK

(71) Applicant: NOKIA SOLUTIONS AND NETWORKS OY, Espoo (FI)

(72) Inventors: Mieszko CHMIEL, Wroclaw (PL); Pawel SAMULAK, Wroclaw (PL)

(21) Appl. No.: 15/222,661

(22) Filed: Jul. 28, 2016

(51) Int. Cl. H04W 72/04; H04W 24/02; H04W 76/04

(52) U.S. Cl. CPC H04W 72/042; H04W 76/045; H04W 76/046; H04W 24/02

(57) ABSTRACT

An example implementation may include determining that a soft buffer size for a transport block of a serving cell in a wireless network has changed, determining a maximum transport block size to be used for downlink data transmission to a user device during a connection reconfiguration process, and causing sending, to the user device during the connection reconfiguration process, a transport block that is less than or equal to the maximum transport block size.

### TECHNICAL FIELD

This description relates to communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations, which are referred to as enhanced Node Bs (eNBs), provide wireless access within a coverage area or cell. In LTE, mobile devices, or mobile stations are referred to as user equipments (UE). LTE has included a number of improvements or developments. 5G, or 5^{th} generation wireless networks are also being developed.

In some wireless networks, such as for LTE, carrier aggregation (CA) may be used in which multiple component carriers may be aggregated and jointly used for transmission to and/or from a user device/user equipment (UE). For example, a primary cell (PCell) may be aggregated with a secondary cell (SCell) to form 2 component carriers for communicating with a UE. A connection reconfiguration may be used to add or drop a component carrier or SCell as part of carrier aggregation. Some parameters may change during a connection reconfiguration.

### SUMMARY

According to an example implementation, a method may include determining that a soft buffer size for a transport block of a serving cell in a wireless network has changed, determining a maximum transport block size to be used for downlink data transmission to a user device during a connection reconfiguration process, and causing sending, to the user device during the connection reconfiguration process, a transport block that is less than or equal to the maximum transport block size.

According to another example implementation, an apparatus may include at least one processor and at least one memory including computer instructions, when executed by the at least one processor, cause the apparatus to: determine that a soft buffer size for a transport block of a serving cell in a wireless network has changed, determine a maximum transport block size to be used for downlink data transmission to a user device during a connection reconfiguration process, and cause sending, to the user device during the connection reconfiguration process, a transport block that is less than or equal to the maximum transport block size.

According to another example implementation, a computer program product may include a computer-readable storage medium and storing executable code that, when executed by at least one data processing apparatus, is configured to cause the at least one data processing apparatus to perform a method including: determining that a soft buffer size for a transport block of a serving cell in a wireless network has changed, determining a maximum transport block size to be used for downlink data transmission to a user device during a connection reconfiguration process, and causing sending, to the user device during the connection reconfiguration process, a transport block that is less than or equal to the maximum transport block size.

According to another example implementation, an apparatus may include means for determining that a soft buffer size for a transport block of a serving cell in a wireless network has changed, means for determining a maximum transport block size to be used for downlink data transmission to a user device during a connection reconfiguration process, and means for causing sending, to the user device during the connection reconfiguration process, a transport block that is less than or equal to the maximum transport block size.

According to an example implementation, a method may include causing receiving, by a user device from a network device, a connection reconfiguration message that causes a soft buffer size for a transport block of a serving cell to change, and causing receiving, by the user device from the network device, during a connection reconfiguration process, a transport block that is less than or equal to a maximum transport block size, wherein the maximum transport block size ensures that the user device will perform full buffer rate matching during the connection reconfiguration process.

According to another example implementation, an apparatus may include at least one processor and at least one memory including computer instructions, when executed by the at least one processor, cause the apparatus to: cause receiving, by a user device from a network device, a connection reconfiguration message that causes a soft buffer size for a transport block of a serving cell to change, and cause receiving, by the user device from the network device, during a connection reconfiguration process, a transport block that is less than or equal to a maximum transport block size, wherein the maximum transport block size ensures that the user device will perform full buffer rate matching during the connection reconfiguration process.

According to another example implementation, a computer program product may include a computer-readable storage medium and storing executable code that, when executed by at least one data processing apparatus, is configured to cause the at least one data processing apparatus to perform a method including: causing receiving, by a user device from a network device, a connection reconfiguration message that causes a soft buffer size for a transport block of a serving cell to change, and causing receiving, by the user device from the network device, during a connection reconfiguration process, a transport block that is less than or equal to a maximum transport block size, wherein the maximum transport block size ensures that the user device will perform full buffer rate matching during the connection reconfiguration process.

According to another example implementation, an apparatus may include means for causing receiving, by a user device from a network device, a connection reconfiguration message that causes a soft buffer size for a transport block of a serving cell to change, and means for causing receiving, by the user device from the network device, during a connection reconfiguration process, a transport block that is less than or equal to a maximum transport block size, wherein the maximum transport block size ensures that the user device will perform full buffer rate matching during the connection reconfiguration process.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating a buffer rate matching method for turbo codes according to an example implementation.

FIG. 3A is a diagram illustrating full buffer rate matching for a code block according to an example implementation.

FIG. 3B is a diagram illustrating limited buffer rate matching for a code block according to an example implementation.

FIG. 4 is a flow chart illustrating operation of a base station (e.g., BS or eNB) according to an example implementation.

FIG. 5 is a flow chart illustrating operation of a user device/UE according to an example implementation.

FIG. 6 is a block diagram of a network device (e.g., base station or mobile station) according to an example implementation.

### DETAILED DESCRIPTION

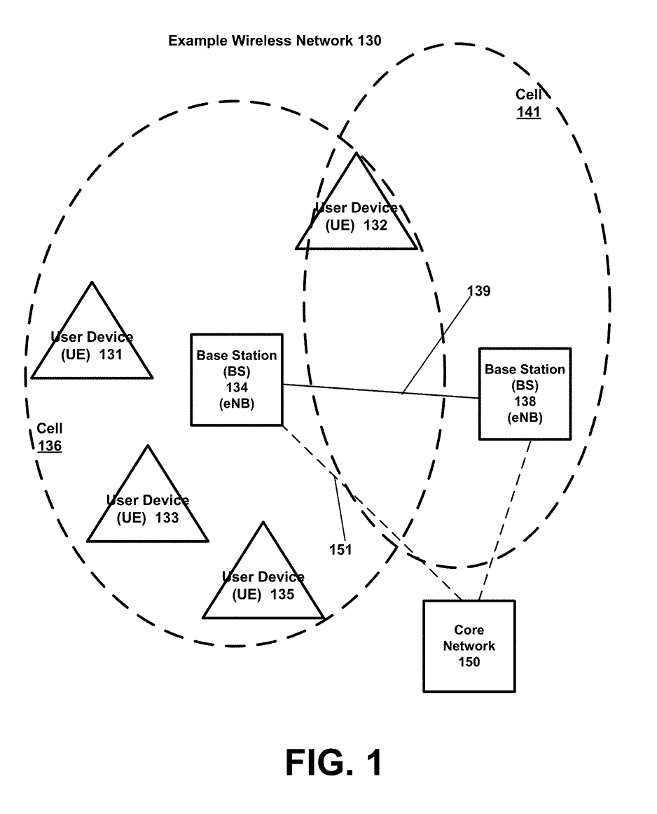

FIG. 1 is a block diagram of a wireless network 130 according to an example implementation. In the wireless network 130 of FIG. 1, user devices 131, 132, 133 and 135, which may also be referred to as user equipments (UEs), may be connected (and in communication) with a base station (BS) 134, which may also be referred to as an evolved Node B (eNB). At least part of the functionalities of a base station or (e)Node B (eNB) may be also be carried out by any node, server or host which may be operably coupled to a transceiver, such as a remote radio head. BS 134 provides wireless coverage (wireless services) within a cell 136, including to user devices 131, 132, 133 and 135. Although only four user devices are shown as being connected or attached to BS 134, any number of user devices may be provided. BS 134 is also connected to a core network 150 via a S1 interface 151.

Also, other BSs and/or cells may also provide wireless services to one or more user devices. For example, as shown in FIG. 1, BS 138 may provide wireless coverage (wireless services) within a cell 141 to one or more user devices. Thus, in this illustrative example, cell 136 is provided by BS 134 and cell 141 is provided by BS 138. Although only two cells and two BSs are shown in FIG. 1, any number may be provided. BS 138 is also connected to core network 150. BS 138 and BS 134 are also connected (and may communicate) via a BS-to-BS (e.g., X2) interface 139. This is merely one simple example of a wireless network, and others may be used. Carrier aggregation may be used, e.g., where cells 136 and 141 may both serve UE 132, for example. For cell aggregation, cells may be aggregated from the same BS, and/or cells may be aggregated from different B Ss.

A user device (user terminal, user equipment (UE)) may refer to a portable computing device that includes wireless mobile communication devices operating with or without a subscriber identification module (SIM), including, but not limited to, the following types of devices: a mobile station, a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network. A user device (or UE) may also include an Internet of Things (IoT) user device/UE, such as for example, a narrowband Internet of Things (NB-IoT) user device/UE.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, and/or mmWave band networks, or any other wireless network. LTE, 5G and mmWave band networks are provided only as illustrative examples, and the various example implementations may be applied to any wireless technology/wireless network.

For example, in an illustrative implementation, the various techniques or implementations described herein may be applied to Internet of Things (IoT) devices/user devices, such as narrowband (NB) IoT (NB-IoT) devices. IoT may refer to an ever-growing group of objects or devices that may have Internet or network connectivity, so that these objects may send information to and receive information from other network devices. For example, many sensor type applications or devices may monitor a physical condition or a status, and may send a report to a server or other network device, e.g., periodically or when an event occurs, by way of illustrative example.

According to an example implementation, a network device may be, for example, a BS or eNB, a user device or mobile station, an IoT device, or any other network device.

In some wireless networks, such as for LTE as an illustrative example, carrier aggregation (CA) may be used in which multiple component carriers may be aggregated and jointly used for transmission to and/or from a user device/user equipment (UE). For example, a primary cell (PCell) may be aggregated with a secondary cell (SCell) to form 2 component carriers for communicating with a UE. A connection reconfiguration process may be used to add or drop a component carrier (one or more SCells) as part of carrier aggregation. For example, a connection reconfiguration process may include a BS or eNB exchanging one or more messages with a UE/user device. For example, as part of an example connection reconfiguration process, a BS or eNB may send a connection reconfiguration message (e.g., a RRCConnectionReconfiguration message) to a UE or user device to request/indicate a change in the connection configuration, which may involve, e.g., adding or dropping (releasing) a component carrier, or changing a parameter associated with a connection. The UE may perform the connection reconfiguration and then send a connection reconfiguration complete (e.g., a RRCConnectionReconfigurationComplete) message to the BS or eNB to confirm or acknowledge the connection reconfiguration, such as, for example, adding or releasing a secondary cell (SCell) if the connection configuration was completed/performed by the UE/user device.

According to an example implementation, a network device (e.g., BS or eNB) may send a connection reconfiguration message to a UE, where the connection reconfiguration message may include one or more parameters, such as a modulation and coding scheme (MCS), a transmission mode, a maximum number of layers, and/or other parameters. The MCS, transmission mode, and maximum number of layers are merely illustrative example parameters, and there may be many (e.g., tens or hundreds of) parameters that may be included in a connection reconfiguration message. A UE category may be indicated (by the BS) and determined by the UE implicitly from the one or more parameters that may be included in the connection reconfiguration message. There may be a plurality of possible UE categories. Each UE category may be associated with or may be determined based on a set of parameters (communication parameters) provided in a connection reconfiguration message sent from a BS to a UE.

Table 1 below indicates some example UE categories, and some of the corresponding parameters. Table 1 is provided merely as an illustrative example, and other parameters and parameter values may be used. As shown in Table 1, some example parameters that may be set or indicated for each UE category may include, for example: a total number of soft channel bits (N_{soft}); and a maximum number of supported MIMO (multiple-input, multiple output) layers for spatial multiplexing in downlink. Thus, it can be seen that different UE categories may have different parameters values, such as different values for N_{soft}, which is the total number of soft channel bits. Although, not shown in Table 1, each UE category may also have a different soft buffer size (N_{IR}) for a transport block.

TABLE 1
Communication parameters for DL transmission

| | | | | Maximum |
|---|---|---|---|---|
| | Maximum | Maximum | | number of |
| | number of DL- | number of bits | | supported |
| | SCH transport | of a DL-SCH | Total number | layers for |
| | block bits | transport | of soft | spatial |
| | received within a | block received | channel bits | multiplexing in |
| UE Category | TTI | within a TTI | (N_{soft}) | DL |
| Category 1 | 10296 | 10296 | 250368 | 1 |
| Category 2 | 51024 | 51024 | 1237248 | 2 |
| Category 3 | 102048 | 75376 | 1237248 | 2 |
| Category 4 | 150752 | 75376 | 1827072 | 2 |
| Category 5 | 299552 | 149776 | 3667200 | 4 |
| Category 6 | 301504 | 149776 (4 | 3654144 | 2 or 4 |
| | | layers, | | |
| | | 64QAM) | | |
| | | 75376 (2 layers, | | |
| | | 64QAM) | | |
| Category 7 | 301504 | 149776 (4 | 3654144 | 2 or 4 |
| | | layers, | | |
| | | 64QAM) | | |
| | | 75376 (2 layers, | | |
| | | 64QAM) | | |
| Category 8 | 2998560 | 299856 | 35982720 | 8 |
| Category 9 | 452256 | 149776 (4 | 5481216 | 2 or 4 |
| | | layers, | | |
| | | 64QAM) | | |
| | | 75376 (2 layers, | | |
| | | 64QAM) | | |
| Category 10 | 452256 | 149776 (4 | 5481216 | 2 or 4 |
| | | layers, | | |
| | | 64QAM) | | |
| | | 75376 (2 layers, | | |
| | | 64QAM) | | |
| Category 11 | 603008 | 149776 (4 | 7308288 | 2 or 4 |
| | | layers, | | |
| | | 64QAM) | | |
| | | 195816 (4 | | |
| | | layers, | | |
| | | 256QAM) | | |
| | | 75376 (2 layers, | | |
| | | 64QAM) | | |
| | | 97896 (2 layers, | | |
| | | 256QAM) | | |
| Category 12 | 603008 | 149776 (4 | 7308288 | 2 or 4 |
| | | layers, | | |
| | | 64QAM) | | |
| | | 195816 (4 | | |
| | | layers, | | |
| | | 256QAM) | | |
| | | 75376 (2 layers, | | |
| | | 64QAM) | | |
| | | 97896 (2 layers, | | |
| | | 256QAM) | | |

Thus, according to an example implementation, when a BS or eNB changes (e.g., by sending a connection reconfiguration message to add or release a SCell) one or more parameters (e.g., modulation scheme or MCS, transmission mode, a maximum number of layers or other parameter) the UE category, the number of soft channel bits (N_{soft}) and/or a soft buffer size (N_{IR}) for a transport block may change. Soft channel bits may be, or may include, for example, bits that are received and stored at the UE/user device, where the UE may reconstruct a received transport block based on combining of soft bits of multiple redundancy versions of one or more code blocks, where there may be 1 or more code blocks per transport block. For example, based on the combining of the data (soft channel bits), the UE may confirm that the CRC (cyclic redundancy check) of the transport block is correct, and then send an Acknowledgement (ACK) to the BS or eNB for the transport block, for example. If the CRC is not correct, then a Negative Acknowledgement (NACK) may typically be sent to the BS or eNB for the transport block.

Some LTE documents will be referenced including:

36.212—LTE; Evolved Universal Terrestrial Radio Access (E-UTRA); Multiplexing and channel coding (3GPP TS 36.212 version 13.1.0 Release 13), referred to herein as 36.212.

36.306—LTE; Universal Terrestrial Radio Access (E-UTRA). User Equipment (UE) radio access capabilities. (3GPP TS 36.306 version 13.1.0 Release 13), referred to herein as 36.306.

36.212 describes how a total number of soft channel bits (N_{soft}) and the soft buffer size for the transport block (N_{IR}) are (or may be) determined. For some UE categories, N_{IR} and N_{soft} may change when one or more communications parameters (e.g., modulation scheme, transmission mode, maximum number of layers or other parameter) are changed, e.g., such as during a SCell addition or SCell release as part of connection reconfiguration. In an illustrative example implementation, N_{IR} may change, at least in some cases, even when N_{soft} does not change. For example, for UE category 6/7, and in an example case where one SCell is added for such a UE in TM4 (transmission mode 4), during such an SCell addition or other change in a communications parameter, N_{IR} and N_{soft} of the UE on the PCell will change as follows, by way of illustrative example:

Before SCell addition: 1CC (single component carrier) TM4 4×4 MIMO (UE can receive max of 4 layers, may use at least 4 RX (receive) antennas, and there may be at least 4 TX (transmit) antennas at BS).
N_{soft}=3654144 (maxLayersMIMO-r10=fourLayers), N_{IR}=228384 (based on ue-Category-v1020=6 or 7);

After SCell addition: 2CC (Carrier Aggregation operation, with 2 component carriers) TM4 4×2 MIMO (a.k.a. 2-layer MIMO transmission with 4TX antennas)+TM4 4×2 MIMO (for each Component carrier, UE can receive a maximum no. of 2 layers via at least 2 RX antennas per cell, hence 4×2); (In this example, XxY means X transmit antennas at BS, and Y MIMO layers the UE can receive).
N_{soft}=1827072, N_{IR}=114192 (based on ue-Category (without suffix)=4).

From 36.212, N_{IR} may be determined based on Nsoft based on the following Eqn. 1:

$${N}_{IR} = ⌊ \frac{{N}_{soft}}{{K}_{C} \cdot {K}_{MIMO} \cdot min ( {M}_{DL \_ HARQ} , {M}_{limit} )} ⌋ \qquad ( Eqn . 1 )$$

Where K_{C}, K_{MIMO}, M_{DL}_{_}_{HARQ} and Mₗᵢₘᵢₜ are variables. It can be seen from Eqn. 1 that N_{IR} may vary (or change) if one or more of N_{soft}, K_{C}, K_{MIMO}, M_{DL}_{_}_{HARQ} or Mₗᵢₘᵢₜ change. Thus, for example, if N_{soft} increases or decreases based on a change in UE category, then this will also cause N_{IR} to increase or decrease, respectively. Also, as noted, N_{IR} may change based on a change of another variable in Eqn. 1, even if N_{soft} does not change.

Also, from 36.212, §5.1.4.1.2, Eqn. 2 below indicates how N_{cb} (a soft buffer size of a code block) is determined, as the minimum of: [floor (N_{IR}/C) or K_{w}], where:

N_{IR} is a soft buffer size at a UE for a transport block, where there are C code blocks per transport block, and where K_{w} is a size of a circular buffer for a code block.

$${N}_{cb} = min ( ⌊ \frac{{N}_{IR}}{C} ⌋ , {K}_{w} ) \qquad ( Eqn . 2 )$$

As described in greater detail below, the value N_{cb} determines the starting points for redundancy versions (RVs) of and a wraparound point or ending point for a code block. Thus, during a connection reconfiguration process, if a UE and a BS have different values for N_{cb}, then this will typically cause different starting points of RVs and wraparound point for a code block at the UE (used for decoding) compared to the BS (compared to the data that was actually transmitted by the BS). Thus, based on this mismatch of the starting points for the RVs and the wraparound or ending point for the code block at the UE, as compared to such starting points and wraparound point used by the BS to transmit the code block, the UE will typically be unable to correctly decode such code block.

According to an illustrative example implementation, the soft buffer size (N_{IR}), which is sometimes also referred to as the UE HARQ (Hybrid ARQ) soft buffer size, may be the total memory/buffer size at the UE over all the HARQ processes for the UE required to support HARQ operation. In some cases, Limited Buffer Rate Matching (LBRM) may be used reduce the required HARQ soft buffer sizes. A reduction in soft buffer size may be enabled by use of LBRM, especially for higher UE categories. However, as described in greater detail herein, a problem may arise where different types of buffer rate matching (full buffer rate matching, or limited buffer rate matching) is being performed at the UE and BS, e.g., during a connection reconfiguration, which may prevent the UE from correctly decoding a received code block. For example, if different values of N_{IR} are used at the UE and BS, then this may cause the UE and BS to perform different (or unsynchronized) buffer rate matching, which may prevent the UE from successfully decoding one or more code blocks. For example, during the connection reconfiguration, if the BS is performing full buffer rate matching while the UE is performing limited buffer rate matching, or if the BS is performing limited buffer rate matching while the UE is performing full buffer rate matching, then this may prevent the UE from decoding one or more code blocks transmitted by the BS.

Therefore, according to an example implementation, to avoid this possible difference or discrepancy in N_{IR} between the UE and the BS during a connection reconfiguration process (e.g., when N_{IR} may be changing), the BS may send and/or transmit only transport blocks that are less than or equal to a threshold size of a transport block transmitted such that:

K_{w} will be less than or equal to floor (N_{IR}/C), as shown by Eqn. 3,

$$⌊ \frac{{N}_{IR}}{C} ⌋ \geq {K}_{w} , \qquad ( Eqn . 3 )$$

And thus, based on Eqn. 3,

$${N}_{cb} = min ( ⌊ \frac{{N}_{IR}}{C} ⌋ , {K}_{w} ) = {K}_{w} . \qquad ( Eqn . 4 )$$

Thus, as shown by Eqns. 3 and 4, N_{cb} may be selected to be equal to K_{w} if a transport block size is less than or equal to a threshold, such that (or to ensure that) K_{w} will be less than or equal to floor (N_{IR}/C).

Note, that during a connection reconfiguration process, the soft buffer size (N_{IR}) of a transport block for a serving cell may change from a first (or initial) soft buffer size to a second (or updated) soft buffer size. For example, initially, a first (or initial) soft buffer size may be used for a serving cell. Then, a BS may send to a UE a connection reconfiguration message that includes one or more parameters that causes or indicates that a second (or updated) soft buffer size for a serving cell will be used, where the second soft buffer size may be different from the first soft buffer size. Note that the first (or initial) soft buffer size may be less than the second (or updated) soft buffer size, or alternatively (depending on the situation), the first soft buffer size may be greater than the second soft buffer size. Thus, to account for both possibilities, a BS or network device may advantageously determine which of the first soft buffer size and the second soft buffer size is smaller (less than the other soft buffer size). Then, according to an example implementation, the BS or network device may determine, based on the smaller soft buffer size, a maximum transport block size to be used for downlink data transmission to a user device during a connection reconfiguration process (or during at least a portion of a connection reconfiguration). Thus, for example, the smaller N_{IR} (smaller between the first soft buffer size and the second soft buffer size) may advantageously be used in Eqns. 3 and 4 to determine a maximum transport block size, such that (or to ensure that) K_{w} will be less than or equal to floor (N_{IR}/C).

In this manner, according to an example implementation, during a transient period or a connection reconfiguration process where N_{IR} has (or may have) changed (e.g., based one or more communication parameters that may have changed and/or a new UE category), the BS may limit the size of transmitted transport block(s), or the BS will transmit transport blocks that are less than or equal to a threshold (or maximum transport block size) size to ensure that N_{cb} will be selected based on K_{w}, and not based on N_{IR}, e.g., such that N_{cb}=K_{w}. Thus, by limiting the transport block size to be less than or equal to a threshold (or less than or equal to a maximum) transport block size during the connection reconfiguration process, a same value of N_{cb} will be applied by both the UE and the eNB for a transport block (because K_{w} is the same for both UE and BS, since K_{w} does not change when N_{soft} and/or N_{IR} changes), thus avoiding the possibility of inconsistent values for N_{cb} between the UE and BS during the transient period or during the connection reconfiguration when one or more parameters may change or be updated by the BS. Thus, by limiting the transport block size to a maximum transport block size (e.g., see Eqns. 3-4) during a connection reconfiguration, this may ensure that (during the connection reconfiguration) the buffer rate matching performed at the UE and the BS will be synchronized or be the same, e.g., a full buffer rate matching is performed by both the UE and the BS during the connection reconfiguration process. This will cause the starting points for the RVs and the wraparound or ending point for the code block received by the UE to be the same as the starting points of the RVs and wraparound point used by the BS to transmit the code block, and thus, allow the code block to be successfully decoded by the UE. Thus, while N_{IR} changes during a connection reconfiguration based on one or more new/updated parameters, K_{w} does not change based on a changing N_{soft} or a changing N_{IR}. Rather K_{w} changes based on the size of the transport block that is transmitted to the UE (thus, K_{w} is known or can be determined by both the UE and the BS). For example, the BS may signal the resources allocated for the transport block and the modulation and coding scheme (MCS) for transmitting the transport block. Thus, the UE may then determine a size of the transport block, and hence also determine K_{w} for the transport block, based on the resource allocation and MCS for the transport block. These example techniques are described in greater detail below.

Therefore, when a connection reconfiguration is performed, e.g., to add or release a SCell (and/or to change one or more communication parameters), this may cause a new or updated (changed) UE category, which may cause N_{IR} to change. Note that the example list of UE categories (shown in Table 1) and events when N_{IR} of a serving cell is changed for the UE is merely an illustrative example and the above case is just one example. Also, for example, in a single carrier (single cell) operation, UE can use all of its soft channel bits for reception of the PCell or single cell; but when a second cell is added, then the soft channel bits are divided among two serving cells.

According to an example implementation, because a SCell addition or release is performed during connection reconfiguration process with an asynchronous connection reconfiguration message (e.g., RRCConnectionReconfiguration message), the BS or eNB does not know the exact TTI (subframe or transmission time interval) in which the UE will switch to the new communications parameters indicated in the connection reconfiguration message. Therefore, before the connection reconfiguration complete message (e.g., RRCConnectionReconfigurationComplete message) is received by the BS or eNB, there is a period of time (e.g., transient period), during or within the connection reconfiguration process, in which the BS and the UE may have different values for N_{IR} of a serving cell. Thus, during at least a portion (or all) of the connection reconfiguration process, which may also be referred to as a transient period, the BS may be using the updated communication parameters (with an updated N_{IR} value), while the UE may still be using the old or initial communication parameters (and the initial or old N_{IR} value), e.g., for at least a portion of the reconfiguration process. Or, alternatively, during the connection reconfiguration, the BS may be using the old (or initial) communication parameters (with an the old or initial N_{IR} value), while the UE may be using the new or updated communication parameters The time period, or at least a portion of the connection reconfiguration process where BS and UE may have different values for N_{IR} and N_{soft} values, may be referred to as a transient period or a transient phase, e.g., because this is a time period during (all or at least a portion of) the connection reconfiguration process, e.g., after the BS has requested the UE to use a new or updated communications parameters (which may be associated with a new or updated UE category), where the UE (or user device) may not yet be using the updated communications parameters or updated UE category (but may still be using the old or initial communications parameters (associated with an old or initial UE category).

According to an example implementation, as described in greater detail, at least in some cases, different types of buffer rate matching may be performed (e.g., either full buffer rate matching, or limited buffer rate matching), depending on the value of N_{IR}. Thus, a problem may arise where the buffer rate matching performed by the BS and the UE are not synchronized (not the same buffer rate matching, e.g., BS may be performing full buffer rate matching, and UE may be performing limited buffer rate matching, or vice versa).

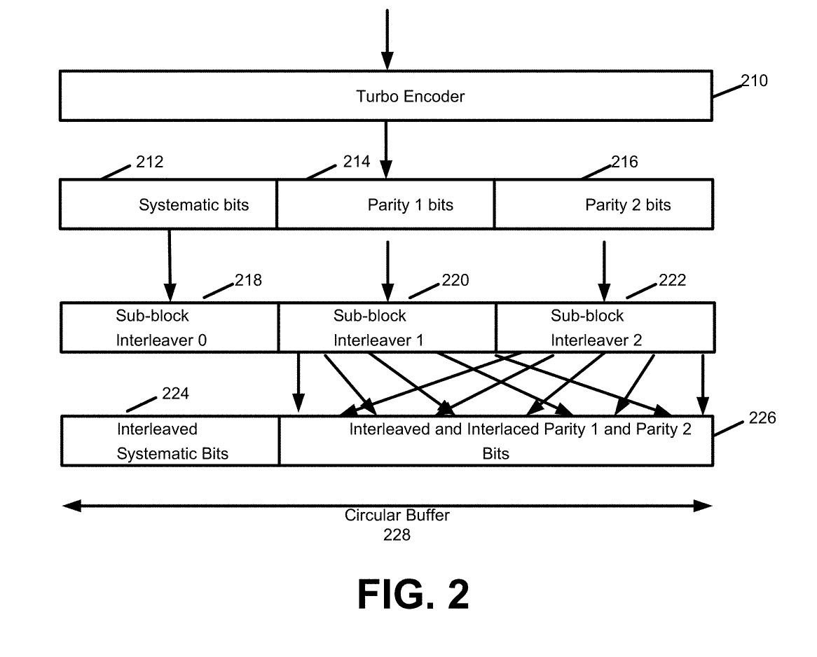

FIG. 2 is a diagram illustrating a buffer rate matching method for turbo codes according to an example implementation. Turbo encoder 210 may perform turbo encoding. For an input block size of K bits, the output of turbo encoder 210 may include three K-bit streams, including a systematic (or data) bit stream 212, and two parity bit streams (Parity 1 bit stream 214, and Parity 2 bit stream 216), along with 12 tail bits due to trellis termination, for example. Each bit stream may be input to a respective sub-block interleaver. Thus, the actual mother code rate is slightly less than 1/3 in this example. In an example buffer rate matching method, for rate 1/3 turbo codes, for example, each of the three output streams of the turbo coder is rearranged (or interleaved) with or by its own sub-block interleaver. Sub-block interleaver 0 218 rearranges/interleaves the systematic bits; sub-block interleaver 1 220 rearranges/interleaves the parity 1 bits; and, sub-block interleaver 2 222 rearranges/interleaves the parity 2 bits. The systematic and parity bits are then output to a circular buffer 228 that includes or stores the interleaved systematic bits 224 first, followed by the rearranged parity 1 and parity 2 bits 226 that have been interleaved. For example, buffer rate matching may use bit puncturing and/or bit repetition to achieve a desired code rate. Buffer rate matching may be performed per code block (or for each code block), where there may be one or more code blocks per transport block.

According to an example implementation, buffer rate matching may include selecting a set or subset of data to be transmitted and received. Buffer rate matching may include determining which systematic bits and parity bits will be transmitted and how many times these bits will be repeated. For example, rate matching may include matching a number of bits in a transport block to a number of bits that can be transmitted in a given allocation, e.g., based on one or more limitations or parameters. In an example implementation, a size of a soft buffer at the UE, as compared to the size of a transport block, may determine whether full buffer rate matching, or limited buffer rate matching will be performed. For example, if the soft buffer size at the UE (size of the UE soft buffer for a transport block (N_{IR}) divided by the number (C) of code blocks per transport block (N_{IR}/C)) is greater than or equal to the size (K_{w}) of the circular buffer for a code block, then the BS may transmit a code block and full buffer rate matching may be used (where N_{cb} will be set equal to K_{w}, as shown in Eqns. 3-4). Thus, full buffer rate matching may be used if the soft buffer size at the UE is sufficiently large to receive the full code block (N_{IR}/C). On the other hand, if the soft buffer size is not large enough, the limited buffer rate matching will typically be used, e.g., where the number of bits (or size, N_{cb}) of a code block are reduced, thereby changing the end or wraparound point for the circular buffer and the starting point for each redundancy version within the circular buffer. According to an example implementation, as noted above, a smaller soft buffer size (the smaller of the initial soft buffer size or the updated soft buffer size at the UE) will be used as N_{IR} in the equations or determinations described above.

Hence, advantageously, the buffer rate matching at the BS should match or be synchronized to the buffer rate matching used by the UE (the same buffer rate matching techniques should be used by both eNB and UE, e.g., both UE and BS may use full buffer rate matching). If different buffer rate matching techniques are used, then the UE may be unable to correctly decode the received code block, e.g., because the starting points for the RVs and the wraparound or ending point for the code block will be incorrect as applied by the UE as compared to these RV starting points and code block wraparound point for the code block as actually transmitted by the BS. Thus, if the buffer rate matching at the BS and the UE are not synchronized, the UE may be unable to correctly decode the received code block, for example.

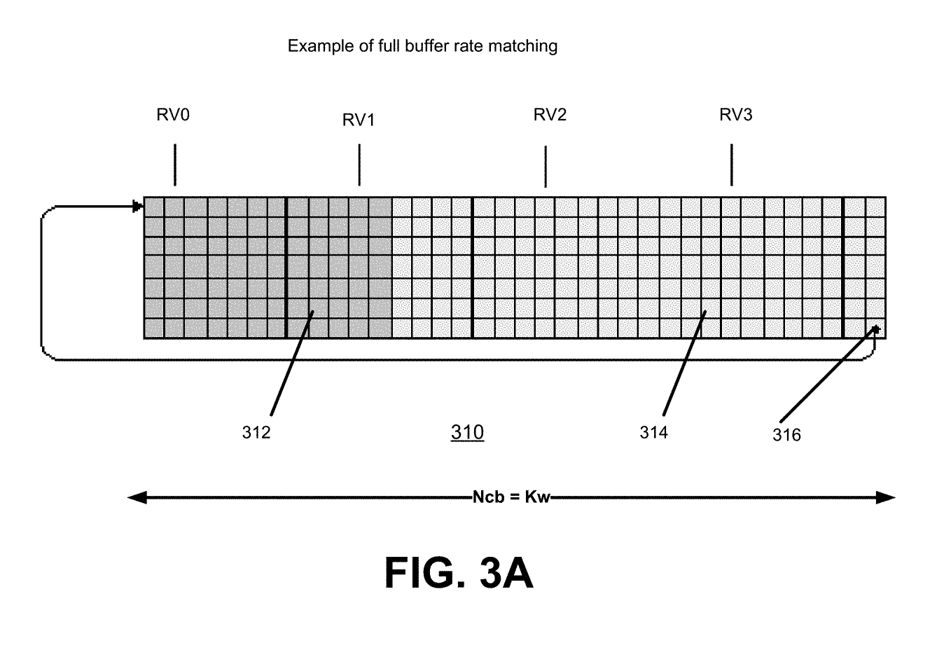

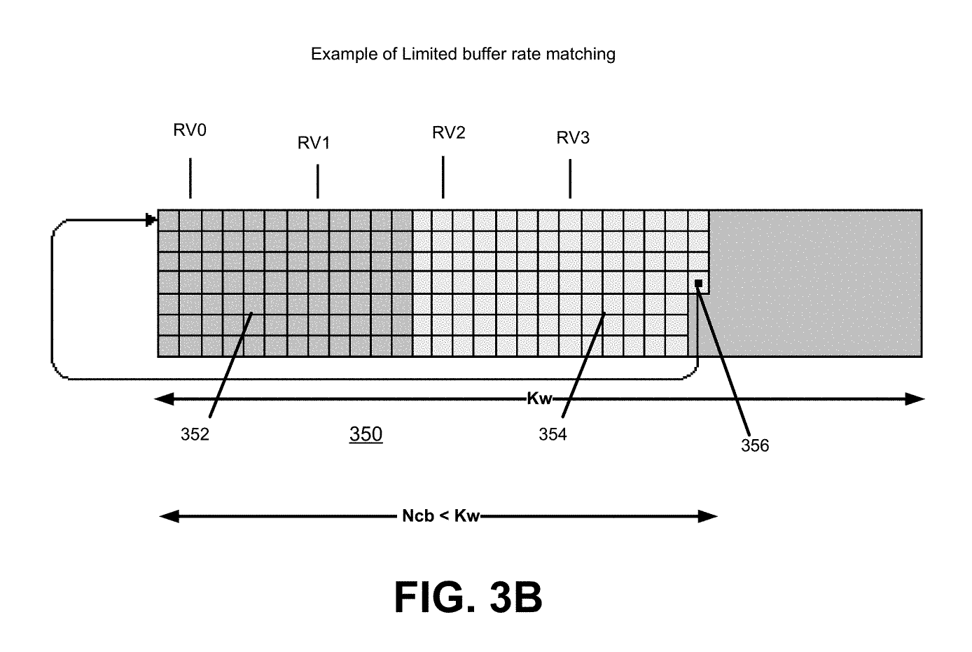

FIG. 3A is a diagram illustrating full buffer rate matching for a code block according to an example implementation. A circular buffer 310 includes bits for a soft buffer size (N_{cb}) of the code block. The circular buffer 310 includes systematic bits 312 followed and parity bits 314. According to an example implementation, incremental redundancy (IR) based HARQ (hybrid automatic repeat request) operation may use the rate matching method to obtain different subsets, denoted as redundancy versions (or RVs), of the code word for transmission. RV0 (redundancy version 0), may typically, for example, start at the beginning of the code block, so that the redundancy version RV0 would include the systematic bits 224, for example. Other redundancy versions, e.g., RV1, RV2, RV3, may each have different starting positions within the bits stored in the circular buffer. The RVs of the code block may be transmitted using one or more downlink transmissions. The starting point of each RV and an ending point or wraparound point 316 of the code block within the circular buffer 310 is determined based on N_{cb}, which is the soft buffer size of the code block. In an illustrative example implementation of full buffer rate matching, as shown in FIG. 3A, the soft buffer size of a code block (N_{cb}) may be set equal to a size (K_{w}) of the circular buffer of a code block.

FIG. 3B is a diagram illustrating limited buffer rate matching for a code block according to an example implementation. A circular buffer 350 includes bits for a soft buffer size (N_{cb}) of the code block. The circular buffer 350 includes systematic bits 352 followed and parity bits 354. As shown in FIG. 3B, RV0 (redundancy version 0), may typically, for example, start at the beginning of the code block, so that the redundancy version RV0 would include the systematic bits 224, for example. Other redundancy versions, e.g., RV1, RV2, RV3, may each have different starting positions within the bits stored in the circular buffer 350. The starting point of each RV and an ending point or wraparound point 316 of the code block within the circular buffer 310 is determined based on N_{cb}, which is the soft buffer size of the code block. In this illustrative example implementation of limited buffer rate matching, soft buffer size of a code block (N_{cb}) is less than a size (K_{w}) of the circular buffer of a code block. Thus, the locations of the RVs, and the wraparound point for the limited buffer rate matching example in FIG. 3B are different based on a different N_{cb}, as compared to the full buffer rate matching example in FIG. 3A.

In this manner, according to an example implementation, during a transient period and/or a during connection reconfiguration process where N_{IR} has (or may have) changed (e.g., based on a new UE category indicated by the BS), the BS may limit the size of transmitted transport blocks, or the BS will transmit transport blocks that are less than or equal to a threshold size to ensure that Ncb will be selected based on K_{w}, and not based on N_{IR}, e.g., such that N_{cb}=K_{w}, per Eqns. 1-4, for example. Thus, by limiting the transport block size to be less than or equal to a threshold size during at least a portion of the connection reconfiguration process, a same value of N_{cb} will be applied by both the UE and the eNB for a transport block (even if N_{IR} is different at the UE and eNB during the connection reconfiguration process), thus avoiding the possibility of inconsistent values for N_{cb}. This may ensure that a same buffer rate matching technique is applied at both the UE and the BS. For example, this may ensure that full buffer rate matching is performed by both the UE and the BS during the connection reconfiguration process. Thus, while N_{IR} changes based on a change of one or more communication parameters (which may include a change of the UE category and N_{soft} and N_{IR}), K_{w} does not change. This may allow a common or same buffer rate matching technique, e.g., full buffer rate matching, to be used by both the UE and the eNB during the connection reconfiguration process, even though the UE and BS may have different values for N_{soft} and N_{IR}. This is because, by limiting the transport block size to be less than or equal to a maximum (or threshold) transport block size, K_{w} is kept sufficiently small to ensure that Eqns. 3 and 4 are true.

According to an illustrative example, K_{w} may be determined based on the transport block size (e.g., proportional to transport block size). For example, K_{w} may be determined as 3Kπ, where: there may be Kπ bits output by turbo encoder 210 as data bits (systematic bits); Kπ bits generated and output by turbo encoder as parity 1 bits, and Kπ bits output by turbo encoder 210 as parity 2 bits. As an illustrative example, Kπ bits may be 256 bits, by way of example. This would mean that, in this illustrative example, there are Kπ (or 256) interleaved systematic bits, and 2Kπ(or 512) interleaved parity 1 and parity 2 bits, for a total of 3Kπ (or 768) bits, and wherein K_{w} is equal to 3Kπ=768 bits, according to this illustrative example.

Thus, according to an example implementation, rate matching errors may be reduced based on the following: If the soft buffer size for the transport block (N_{IR}) of a serving cell is changed during an RRC connection reconfiguration, the BS should make sure that the BS and the UE have the same value for the soft buffer size for the r-th code block (N_{cb}) by applying restrictions to the transmission on that serving cell during the transient period. Where the restriction includes scheduling (and then transmitting) a transport block(s), e.g., during at least a portion of the connection reconfiguration, with a transport block size which is equal to or less than a threshold so that it is ensured that limited buffer rate matching is not performed by the UE or eNB, but rather, to ensure that full buffer rate matching is used by both UE and eNB. Thus, full buffer rate matching can be ensured at both the UE and eNB if, for example, K_{w} is kept sufficiently small to ensure that Eqns. 3 and 4 are true, even if N_{IR} may be (at least temporarily) different at the UE and BS during the transient period or the connection reconfiguration process.

For example, based on 36.212 and 36.306, it is determined if N_{IR} of a serving cell is changed during a given RRC reconfiguration (the input is N_{soft}, K_{C} and K_{MIMO} before and after reconfiguration), and if yes (if N_{IR} of a serving cell has changed) then, for example:

It is ensured that

$$⌊ \frac{{N}_{IR}}{C} ⌋ \geq {K}_{w} ,$$

then

$${N}_{cb} = min ( ⌊ \frac{{N}_{IR}}{C} ⌋ , {K}_{w} ) = {K}_{w} .$$

This means that the soft buffer size for the r-th code block (N_{cb}) does not depend on the soft buffer size for the transport block (N_{IR}) so even if the BS and the UE have different assumptions on (or values for) N_{IR} (because it is changed during RRC reconfiguration) the BS and the UE rate matching engines are still in synchronization (still synchronized, e.g., both UE and BS are performing full buffer rate matching).

Based on 36.212, it can be calculated what transport block size threshold (or maximum transport block size) will ensure that

$$⌊ \frac{{N}_{IR}}{C} ⌋ \geq {K}_{w} ,$$

the threshold can be, by way of illustrative example:

Variable depending on a given N_{IR} reconfiguration: The UE's soft buffers were dimensioned by 3GPP for relevant UE categories so that limited buffer rate matching kicks in (is performed) when the transport block size is greater than approximately half of the maximum transport block size of the UE category. Therefore, a rule of thumb may be used where the threshold size is used that is half of the “Maximum number of bits of a DL-SCH transport block received within a TTI” [36.306] of the (lower if changed) UE category during reconfiguration.

Fixed worst case may be applied to all N_{IR} reconfiguration cases to simplify implementation. The determined threshold may, for example, be used as the limit of the transport block size scheduled on the serving cell during the transient period when N_{IR} of the serving cell is changed (e.g., by a connection reconfiguration message from the eNB).

One or more of these example techniques may have one or more of the following illustrative example advantages:

Transmission failures due to inconsistent rate matching are avoided during transient periods (or during connection reconfiguration).

No need to stop transmission during transient periods.

No need to use intra-eNB handover for SCell addition/release or other RRC reconfigurations when N_{IR} is changed.

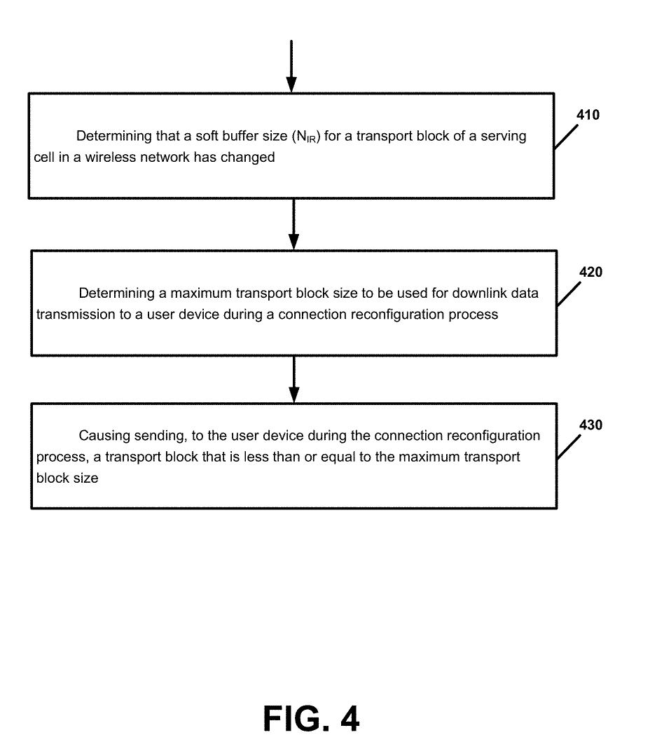

FIG. 4 is a flow chart illustrating operation of an apparatus e.g. a network device, which may be or may include a base station (e.g., BS) or other network device according to an example implementation. Operation 410 includes determining that a soft buffer size (N_{IR}) for a transport block of a serving cell of a wireless network has changed. Operation 420 includes determining a maximum transport block size to be used for downlink data transmission to a user device during a connection reconfiguration process. And, operation 430 includes causing sending, to the user device during the connection reconfiguration process, a transport block that is less than or equal to the maximum transport block size.

According to an example implementation of the method of FIG. 4, the determining a maximum transport block size may include: determining, by a network device for each of one or more transport blocks, a maximum transport block size to be used for downlink data transmission from the network device to a user device during a connection reconfiguration process.

According to an example implementation of the method of FIG. 4, the causing sending may include causing sending, to the user device during the connection reconfiguration process, a plurality of transport blocks, wherein each of the plurality of transport blocks is less than or equal to a determined maximum transport block size.

According to an example implementation of the method of FIG. 4, the network device may include a base station.

According to an example implementation of the method of FIG. 4, the determining that a soft buffer size for a transport block of a serving cell in a wireless network has changed may include determining that a soft buffer size for a transport block of a serving cell has changed from a first soft buffer size to a second soft buffer size; and wherein the determining a maximum transport block size includes: determining which of the first soft buffer size and the second soft buffer size is smaller; determining, based on the smaller soft buffer size, a maximum transport block size to be used for downlink data transmission to a user device during a connection reconfiguration process.

According to an example implementation of the method of FIG. 4, the determining may include: determining, by a network device, a maximum transport block size to be used for downlink data transmission from the network device to a user device during a connection reconfiguration process, wherein the maximum transport block size is determined such that buffer rate matching performed by the network device will be synchronized with buffer rate matching performed by the user device during the connection reconfiguration process.

According to an example implementation of the method of FIG. 4, the determining a maximum transport block size may include: determining, by a network device, a maximum transport block size to be used for downlink data transmission from the network device to a user device during a connection reconfiguration process, wherein the maximum transport block size is determined to ensure that the network device and the user device have a same value for a soft buffer size (N_{cb}) of a code block and there are one or more code blocks per transport block, such that buffer rate matching at the network device and buffer rate matching at the user device are synchronized.

According to an example implementation of the method of FIG. 4, the determining a maximum transport block size may include: determining, by a network device, a maximum transport block size to be used for downlink data transmission from the network device to a user device during a connection reconfiguration process, wherein the maximum transport block size is determined such that full buffer rate matching will be performed by both the network device and the user device during the connection reconfiguration process.

According to an example implementation of the method of FIG. 4, determining a maximum transport block size includes determining a maximum transport block size to be used for downlink data transmission to a user device during a connection reconfiguration process, wherein the maximum transport block size is determined to ensure that a soft buffer size of a code block (N_{cb}) is set equal to a size of a circular buffer for a code block (K_{w}) during the connection reconfiguration process.

According to an example implementation of the method of FIG. 4, the determining a maximum transport block size may include determining a maximum transport block size to be used for downlink data transmission to a user device a connection reconfiguration process, wherein the maximum transport block size is determined to ensure that N_{cb} is set equal to K_{w} due to

$$( ⌊ \frac{{N}_{IR}}{C} ⌋ \geq {K}_{w} , \\ and \\ {N}_{cb} = min ( ⌊ \frac{{N}_{IR}}{C} ⌋ , {K}_{w} ) = {K}_{w} ,$$

where C is a number of code blocks in a transport block, N_{cb} is a soft buffer size of a code block, and K_{w} is a size of a circular buffer for a code block, and where

$$( ⌊ \frac{{N}_{IR}}{C} ⌋ )$$

is a floor(N_{IR}/C), wherein N_{IR} is selected to be a smaller of a first soft buffer size and a second soft buffer size.

According to an example implementation of the method of FIG. 4, and further including causing sending, from a network device to the user device, a plurality of parameters for the transmission of the transport block during the connection reconfiguration process, the plurality of parameters including a downlink resource assignment for the transport block and a modulation and coding scheme (MCS) to be used for transmission of the transport block.

According to an example implementation of the method of FIG. 4, wherein the determining that a soft buffer size (N_{IR}) for a transport block has changed may include: determining that a soft buffer size (N_{IR}) for a transport block has changed based on a connection reconfiguration for a user device.

According to an example implementation of the method of FIG. 4, wherein the determining that a soft buffer size (N_{IR}) for a transport block has changed may include: causing sending, by a network device to the user device, a connection reconfiguration message that causes the soft buffer size to change for the serving cell.

According to an example implementation of the method of FIG. 4, wherein the connection reconfiguration process may include an exchange of messages between a network device and user device to reconfigure a connection, the connection reconfiguration process including at least the following messages:

a RRCConnectionReconfiguration message sent by the network device (e.g., base station) to the user device; and

a RRCConnectionReconfigurationComplete message received by the network device from the user device.

According to an example implementation of the method of FIG. 4, the causing sending may include: causing sending to the user device during the connection reconfiguration process, at least one code block of the transport block that is less than or equal to the maximum transport block size, wherein there is one or more code blocks per transport block.

An apparatus includes at least one processor and at least one memory including computer instructions, when executed by the at least one processor, cause the apparatus to: determine that a soft buffer size (N_{IR}) for a transport block of a serving cell has changed; determine a maximum transport block size to be used for downlink data transmission to a user device during a connection reconfiguration process; and cause sending, to the user device during the connection reconfiguration process, at least one transport block that is less than or equal to the maximum transport block size.

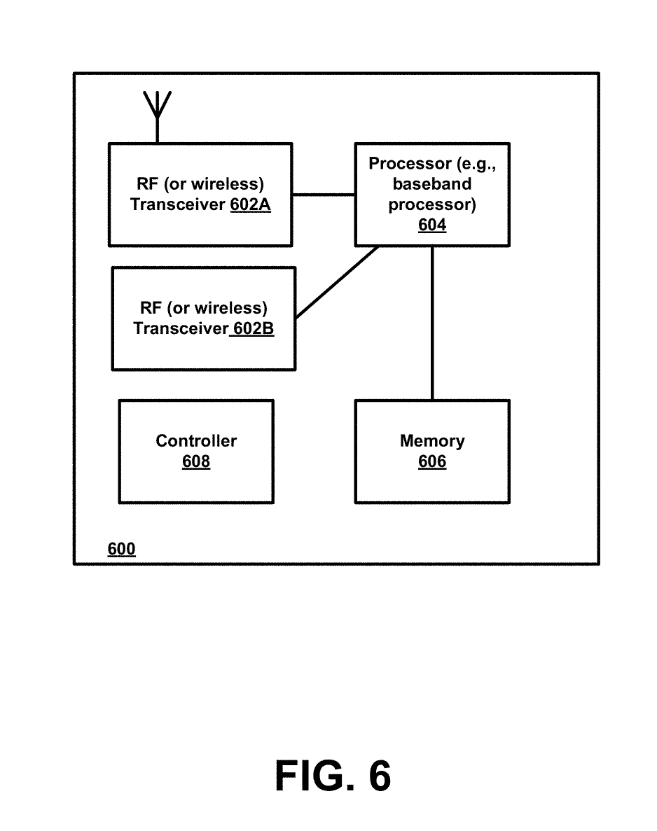

According to an example implementation an apparatus may include means (e.g., 602A or 602B, and/or 604, FIG. 6) for determining that a soft buffer size (N_{IR}) for a transport block of a serving cell in a wireless network has changed, means (e.g., 602A or 602B, and/or 604, FIG. 6) for determining a maximum transport block size to be used for downlink data transmission to a user device during a connection reconfiguration process, and means (e.g., 602A or 602B, and/or 604, FIG. 6) for causing sending, to the user device during the connection reconfiguration process, a transport block that is less than or equal to the maximum transport block size.

According to an example implementation, the means for determining a maximum transport block size may include: means (e.g., 602A or 602B, and/or 604, FIG. 6) for determining, by a network device for each of one or more transport blocks, a maximum transport block size to be used for downlink data transmission from the network device to a user device during a connection reconfiguration process.

According to an example implementation, the means for causing sending may include means (e.g., 602A or 602B, and/or 604, FIG. 6) for causing sending, to the user device during the connection reconfiguration process, a plurality of transport blocks, wherein each of the plurality of transport blocks is less than or equal to a determined maximum transport block size.

According to an example implementation, the network device may include a base station.

According to an example implementation, the means for determining that a soft buffer size for a transport block of a serving cell in a wireless network has changed may include means (e.g., 602A or 602B, and/or 604, FIG. 6) for determining that a soft buffer size for a transport block of a serving cell has changed from a first soft buffer size to a second soft buffer size; and wherein the means for determining a maximum transport block size includes: means (e.g., 602A or 602B, and/or 604, FIG. 6) for determining which of the first soft buffer size and the second soft buffer size is smaller; and, means (e.g., 602A or 602B, and/or 604, FIG. 6) for determining, based on the smaller soft buffer size, a maximum transport block size to be used for downlink data transmission to a user device during a connection reconfiguration process.

According to an example implementation, the means for determining may include: means (e.g., 602A or 602B, and/or 604, FIG. 6) for determining, by a network device, a maximum transport block size to be used for downlink data transmission from the network device to a user device during a connection reconfiguration process, wherein the maximum transport block size is determined such that buffer rate matching performed by the network device will be synchronized with buffer rate matching performed by the user device during the connection reconfiguration process.

According to an example implementation, the means for determining a maximum transport block size may include: means (e.g., 602A or 602B, and/or 604, FIG. 6) for determining, by a network device, a maximum transport block size to be used for downlink data transmission from the network device to a user device during a connection reconfiguration process, wherein the maximum transport block size is determined to ensure that the network device and the user device have a same value for a soft buffer size (N_{cb}) of a code block and there are one or more code blocks per transport block, such that buffer rate matching at the network device and buffer rate matching at the user device are synchronized.

According to an example implementation, the means for determining a maximum transport block size may include: means (e.g., 602A or 602B, and/or 604, FIG. 6) for determining, by a network device, a maximum transport block size to be used for downlink data transmission from the network device to a user device during a connection reconfiguration process, wherein the maximum transport block size is determined such that full buffer rate matching will be performed by both the network device and the user device during the connection reconfiguration process.

According to an example implementation, the means for determining a maximum transport block size includes means (e.g., 602A or 602B, and/or 604, FIG. 6) for determining a maximum transport block size to be used for downlink data transmission to a user device during a connection reconfiguration process, wherein the maximum transport block size is determined to ensure that a soft buffer size of a code block (N_{cb}) is set equal to a size of a circular buffer for a code block (K_{w}) during the connection reconfiguration process.

According to an example implementation, the means for determining a maximum transport block size may include means (e.g., 602A or 602B, and/or 604, FIG. 6) for determining a maximum transport block size to be used for downlink data transmission to a user device a connection reconfiguration process, wherein the maximum transport block size is determined to ensure that N_{cb} is set equal to K_{w} due to

$$⌊ \frac{{N}_{IR}}{C} ⌋ \geq {K}_{w} , \\ and$$

$${N}_{cb} = min ( ⌊ \frac{{N}_{IR}}{C} ⌋ , {K}_{w} ) = {K}_{w} ,$$

where C is a number of code blocks in a transport block, N_{cb} is a soft buffer size of a code block, and K_{w} is a size of a circular buffer for a code block, and where

$$( ⌊ \frac{{N}_{IR}}{C} ⌋ )$$

is a floor(N_{IR}/C), wherein N_{IR} is selected to be a smaller of a first soft buffer size and a second soft buffer size.

According to an example implementation, the apparatus may further include means (e.g., 602A or 602B, and/or 604, FIG. 6) for causing sending, from a network device to the user device, a plurality of parameters for the transmission of the transport block during the connection reconfiguration process, the plurality of parameters including a downlink resource assignment for the transport block and a modulation and coding scheme (MCS) to be used for transmission of the transport block.

According to an example implementation, wherein the means for determining that a soft buffer size (N_{IR}) for a transport block has changed may include: determining that a soft buffer size (N_{IR}) for a transport block has changed based on a connection reconfiguration for a user device.

According to an example implementation, the means for determining that a soft buffer size (N_{IR}) for a transport block has changed may include: means (e.g., 602A or 602B, and/or 604, FIG. 6) for causing sending, by a network device to the user device, a connection reconfiguration message that causes the soft buffer size to change for the serving cell.

According to an example implementation, wherein the connection reconfiguration process may include an exchange of messages between a network device and user device to reconfigure a connection, the connection reconfiguration process including at least the following messages:

a RRCConnectionReconfiguration message sent by the network device (e.g., base station) to the user device; and

a RRCConnectionReconfigurationComplete message received by the network device from the user device.

According to an example implementation, the means for causing sending may include: means (e.g., 602A or 602B, and/or 604, FIG. 6) for causing sending to the user device during the connection reconfiguration process, at least one code block of the transport block that is less than or equal to the maximum transport block size, wherein there is one or more code blocks per transport block.

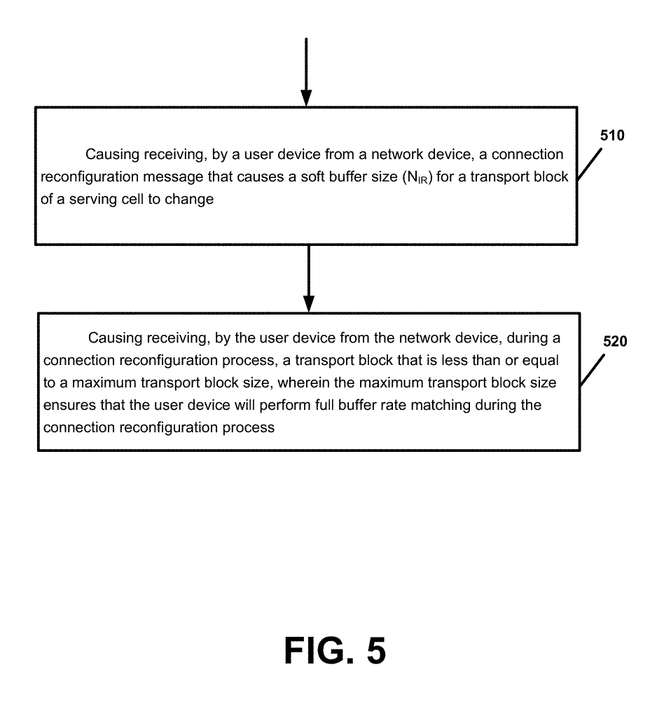

FIG. 5 is a flow chart illustrating operation of an apparatus (e.g. a user device or UE) according to an example implementation. Operation 510 includes causing receiving, by a user device from a network device (e.g., base station), a connection reconfiguration message that causes a soft buffer size (N_{IR}) for a transport block of a serving cell to change. Operation 520 includes causing receiving, by the user device from the network device, during a connection reconfiguration process, a transport block that is less than or equal to a maximum transport block size, wherein the maximum transport block size ensures that the user device will perform full buffer rate matching during the connection reconfiguration process.

According to an example implementation of the method of FIG. 5, during the connection reconfiguration process, the user device receiving the transport block that is less than or equal to the maximum transport block size ensures that, during the connection reconfiguration process, both the network device (e.g., BS) and the user device will perform full buffer rate matching, even if the network device and the user device have different values for the soft buffer size (N_{IR}).

According to an example implementation of the method of FIG. 5, wherein, during the connection reconfiguration process, the user device receiving the transport block that is less than or equal to the maximum transport block size ensures that a soft buffer size of a code block is set equal to a size of a circular buffer for a code block during the connection reconfiguration process, e.g., N_{cb} is set equal to K_{w}, where N_{cb} is a soft buffer size of a code block, and K_{w} is a size of a circular buffer for a code block.

According to an example implementation of the method of FIG. 5, further including causing receiving, by the user device from the network device, a plurality of parameters for the transmission of the transport block during at least a portion of the connection reconfiguration process, the plurality of parameters including a downlink resource assignment for the transport block and a modulation and coding scheme (MCS) to be used for receiving the transport block.

According to an example implementation of the method of FIG. 5, wherein the connection reconfiguration process includes an exchange of messages between the network device and user device to reconfigure a connection, the connection reconfiguration process including at least the following messages:

a RRCConnectionReconfiguration message received by the user device from the network device; and

a RRCConnectionReconfigurationComplete message sent by the user device to the network device.

According to an example implementation of the method of FIG. 5, wherein the soft buffer size for the transport block of the serving cell has changed from a first soft buffer size to a second soft buffer size; and wherein the maximum transport block size to be used has been determined based on a smaller soft buffer size of the first soft buffer size and the second soft buffer size.

An apparatus includes at least one processor and at least one memory including computer instructions, when executed by the at least one processor, cause the apparatus to: receive, by a user device from a network device, a connection reconfiguration message that causes a soft buffer size (N_{IR}) for a transport block of a serving cell to change; and receive, by the user device from the network device, during a connection reconfiguration process, a transport block that is less than or equal to a maximum transport block size, wherein the maximum transport block size ensures that the user device will perform full buffer rate matching during the connection reconfiguration process.

According to an example implementation, an apparatus may include means (e.g., 602A or 602B, and/or 604, FIG. 6) for causing receiving, by a user device from a network device (e.g., base station), a connection reconfiguration message that causes a soft buffer size (N_{IR}) for a transport block of a serving cell to change, and means (e.g., 602A or 602B, and/or 604, FIG. 6) for causing receiving, by the user device from the network device, during a connection reconfiguration process, a transport block that is less than or equal to a maximum transport block size, wherein the maximum transport block size ensures that the user device will perform full buffer rate matching during the connection reconfiguration process.

According to an example implementation of the apparatus, during the connection reconfiguration process, the user device receiving the transport block that is less than or equal to the maximum transport block size ensures that, during the connection reconfiguration process, both the network device (e.g., BS) and the user device will perform full buffer rate matching, even if the network device and the user device have different values for the soft buffer size (N_{IR}).

According to an example implementation of the apparatus, wherein, during the connection reconfiguration process, the means for receiving the transport block that is less than or equal to the maximum transport block size ensures that a soft buffer size of a code block is set equal to a size of a circular buffer for a code block during the connection reconfiguration process, e.g., N_{cb} is set equal to K_{w}, where N_{cb} is a soft buffer size of a code block, and K_{w} is a size of a circular buffer for a code block

According to an example implementation of the apparatus, the apparatus further including means (e.g., 602A or 602B, and/or 604, FIG. 6) for causing receiving, by the user device from the network device, a plurality of parameters for the transmission of the transport block during at least a portion of the connection reconfiguration process, the plurality of parameters including a downlink resource assignment for the transport block and a modulation and coding scheme (MCS) to be used for receiving the transport block.

According to an example implementation of the apparatus, wherein the connection reconfiguration process includes an exchange of messages between the network device and user device to reconfigure a connection, the connection reconfiguration process including at least the following messages:

a RRCConnectionReconfiguration message received by the user device from the network device; and

a RRCConnectionReconfigurationComplete message sent by the user device to the network device.

FIG. 6 is a block diagram of a network device (e.g., BS or user device or UE, or other network device) 600 according to an example implementation. The network device 600 may include, for example, two RF (radio frequency) or wireless transceivers 602A, 602B, where each wireless transceiver includes a transmitter to transmit signals and a receiver to receive signals. The network device also includes a processor or control unit/entity (controller) 604 to execute instructions or software and control transmission and receptions of signals, and a memory 606 to store data and/or instructions.

Processor 604 may also make decisions or determinations, generate frames, packets or messages for transmission, decode received frames or messages for further processing, and other tasks or functions described herein. Processor 604, which may be a baseband processor, for example, may generate messages, packets, frames or other signals for transmission via wireless transceiver 602 (602A or 602B). Processor 604 may control transmission of signals or messages over a wireless network, and may control the reception of signals or messages, etc., via a wireless network (e.g., after being down-converted by wireless transceiver 602, for example). Processor 604 may be programmable and capable of executing software or other instructions stored in memory or on other computer media to perform the various tasks and functions described above, such as one or more of the tasks or methods described above. Processor 604 may be (or may include), for example, hardware, programmable logic, a programmable processor that executes software or firmware, and/or any combination of these. Using other terminology, processor 604 and transceiver 602 together may be considered as a wireless transmitter/receiver system, for example.

In addition, referring to FIG. 6, a controller (or processor) 608 may execute software and instructions, and may provide overall control for the station 600, and may provide control for other systems not shown in FIG. 6, such as controlling input/output devices (e.g., display, keypad), and/or may execute software for one or more applications that may be provided on network device 600, such as, for example, an email program, audio/video applications, a word processor, a Voice over IP application, or other application or software.

In addition, a storage medium may be provided that includes stored instructions, which when executed by a controller or processor may result in the processor 604, or other controller or processor, performing one or more of the functions or tasks described above.

According to another example implementation, RF or wireless transceiver(s) 602A/602B may receive signals or data and/or transmit or send signals or data. Processor 604 (and possibly transceivers 602A/602B) may control the RF or wireless transceiver 602A or 602B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (JOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
determining that a soft buffer size for a transport block of a serving cell in a wireless network has changed;
determining a maximum transport block size to be used for downlink data transmission to a user device during a connection reconfiguration process; and
causing sending, to the user device during the connection reconfiguration process, a transport block that is less than or equal to the maximum transport block size.

2. The method of claim 1 wherein the determining a maximum transport block size comprises:
determining, by a network device for each of one or more transport blocks, a maximum transport block size to be used for downlink data transmission from the network device to a user device during a connection reconfiguration process.

3. The method of claim 2 wherein the causing sending comprises:
causing sending, to the user device during the connection reconfiguration process, a plurality of transport blocks, wherein each of the plurality of transport blocks is less than or equal to a determined maximum transport block size.

4. The method of claim 2 wherein the network device comprises a base station.

5. The method of claim 1:
wherein the determining that a soft buffer size for a transport block of a serving cell in a wireless network has changed comprises determining that a soft buffer size for a transport block of a serving cell has changed from a first soft buffer size to a second soft buffer size; and
wherein the determining a maximum transport block size comprises:
determining which of the first soft buffer size and the second soft buffer size is smaller; and
determining, based on the smaller soft buffer size, a maximum transport block size to be used for downlink data transmission to a user device during a connection reconfiguration process.

6. The method of claim 1 wherein the determining a maximum transport block size comprises:
determining, by a network device, a maximum transport block size to be used for downlink data transmission from the network device to a user device during the connection reconfiguration process, wherein the maximum transport block size is determined such that buffer rate matching performed by the network device will be synchronized with buffer rate matching performed by the user device during the connection reconfiguration process.

7. The method of claim 1 wherein the determining a maximum transport block size comprises:
determining, by a network device, a maximum transport block size to be used for downlink data transmission from the network device to a user device during a connection reconfiguration process, wherein the maximum transport block size is determined to ensure that the network device and the user device have a same value for a soft buffer size of a code block and there are one or more code blocks per transport block, such that buffer rate matching at the network device and buffer rate matching at the user device are synchronized.

8. The method of claim 1 wherein the determining a maximum transport block size comprises:
determining, by a network device, a maximum transport block size to be used for downlink data transmission from the network device to a user device during a connection reconfiguration process, wherein the maximum transport block size is determined such that full buffer rate matching will be performed by both the network device and the user device during the connection reconfiguration process.

9. The method of claim 1 wherein the determining a maximum transport block size comprises:
determining a maximum transport block size to be used for downlink data transmission to a user device during a connection reconfiguration process, wherein the maximum transport block size is determined to ensure that a soft buffer size of a code block is set equal to a size of a circular buffer for a code block during the connection reconfiguration process.

10. The method of claim 1 wherein the determining a maximum transport block size comprises:
determining a maximum transport block size to be used for downlink data transmission to a user device during a connection reconfiguration process, wherein the maximum transport block size is determined to ensure that N_{cb} is set equal to K_{w} due to
$$⌊ \frac{{N}_{IR}}{C} ⌋ \geq {K}_{w} , \\ and$$
$${N}_{cb} = min ( ⌊ \frac{{N}_{IR}}{C} ⌋ , {K}_{w} ) = {K}_{w} ,$$
where C is a number of code blocks in a transport block, N_{cb} is a soft buffer size of a code block and K_{w} is a size of a circular buffer for a code block, and where
$$( ⌊ \frac{{N}_{IR}}{C} ⌋ ) ⌊ \frac{{N}_{IR}}{C} ⌋$$
is a floor(N_{IR}/C), where N_{IR} is selected to be a smaller of a first soft buffer size and a second soft buffer size.

11. The method of claim 1 wherein the determining that a soft buffer size for a transport block has changed comprises:
determining that a soft buffer size for a transport block has changed based on a connection reconfiguration for a user device.

12. The method of claim 1 wherein the determining that a soft buffer size for a transport block has changed comprises:
causing sending, by a network device to the user device, a connection reconfiguration message that causes the soft buffer size to change for the serving cell.

13. The method of claim 1 wherein the connection reconfiguration process comprises an exchange of messages between a network device and the user device to reconfigure a connection, the connection reconfiguration process including at least a time period between the following messages:
a RRCConnectionReconfiguration message sent by the network device to the user device; and
a RRCConnectionReconfigurationComplete message received by the network device from the user device.

14. The method of claim 1 wherein the causing sending comprises:
causing sending, to the user device during the connection reconfiguration process, at least one code block of the transport block that is less than or equal to the maximum transport block size, wherein there is one or more code blocks per transport block.

15. An apparatus comprising at least one processor and at least one memory including computer instructions, when executed by the at least one processor, cause the apparatus to:
determine that a soft buffer size for a transport block of a serving cell in a wireless network has changed;
determine a maximum transport block size to be used for downlink data transmission to a user device during a connection reconfiguration process; and
cause sending, to the user device during the connection reconfiguration process, a transport block that is less than or equal to the maximum transport block size.

16. A method comprising:
causing receiving, by a user device from a network device, a connection reconfiguration message that causes a soft buffer size for a transport block of a serving cell to change; and
causing receiving, by the user device from the network device, during a connection reconfiguration process, a transport block that is less than or equal to a maximum transport block size, wherein the maximum transport block size ensures that the user device will perform full buffer rate matching during the connection reconfiguration process.

17. The method of claim 16 wherein, during the connection reconfiguration process, the user device receiving the transport block that is less than or equal to the maximum transport block size ensures that, during the connection reconfiguration process, both the network device and the user device will perform full buffer rate matching, even if the network device and the user device have different values for the soft buffer size.

18. The method of claim 16 wherein, during the connection reconfiguration process, the user device receiving the transport block that is less than or equal to the maximum transport block size ensures that a soft buffer size of a code block is set equal to a size of a circular buffer for a code block during the connection reconfiguration process

19. The method of claim 16 and further comprising:
wherein the soft buffer size for the transport block of the serving cell has changed from a first soft buffer size to a second soft buffer size; and
wherein the maximum transport block size to be used has been determined based on a smaller soft buffer size of the first soft buffer size and the second soft buffer size.

20. The method of claim 16 wherein the connection reconfiguration process comprises an exchange of messages between the network device and the user device to reconfigure a connection, the connection reconfiguration process including at least the following messages:
a RRCConnectionReconfiguration message received by the user device from a network device; and
a RRCConnectionReconfigurationComplete message sent by the user device to the network device.
